(19) United States
(12) Patent Application Publication
(10) Pub. No.: US 2025/0267455 A1
(43) Pub. Date: Aug. 21, 2025

(54) Authentication Proxy Use in Authentication and Key Management for Applications

(71) Applicant: Apple Inc., Cupertino, CA (US)

(72) Inventors: Shu Guo, Beijing (CN); Huarui Liang, Beijing (CN); Dawei Zhang, Saratoga, CA (US); Haijing Hu, Los Gatos, CA (US); Xiaoyu Qiao, Beijing (CN); Lanpeng Chen, Beijing (CN)

(21) Appl. No.: 18/856,507

(22) PCT Filed: May 6, 2022
(86) PCT No.: PCT/CN2022/091121

§ 371 Date: Oct. 11, 2024

(51) Int. Cl. H04W 12/06; H04L 9/40

(52) U.S. Cl. CPC H04W 12/06; H04L 63/166

(57) ABSTRACT

This disclosure relates to techniques for utilizing an authentication proxy in authentication and key management for applications in a wireless communication system. An authentication proxy in a cellular network may receive a request to establish an application session from a wireless device. Authentication of the wireless device may be performed with an authentication anchor function associated with the cellular network to obtain an authentication result. The authentication proxy may provide an indication of the authentication result to an application server associated with the application session.

### PRIORITY INFORMATION

This application is a national stage entry of PCT Application No. PCT/CN2022/091121, entitled “Authentication Proxy Use in Authentication and Key Management for Applications,” filed May 6, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for utilizing an authentication proxy in authentication and key management for applications in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Still further, with the increasing connectivity of devices and diversity of services available, providing robust and efficient authentication techniques to protect the privacy and integrity of data communicated in a wireless communication system may be of great importance. Accordingly, improvements in the field are desired.

### SUMMARY

Embodiments are presented herein of apparatuses, systems, and methods for utilizing an authentication proxy in authentication and key management for applications in a wireless communication system.

According to the techniques described herein, an authentication proxy may perform authentication of a wireless device to support establishment of application sessions for the wireless device in a wireless communication system. One aspect of such authentication may include possible use of shared secure transport tunnels between the authentication proxy and a wireless device for multiple application sessions. For example, it may be possible for either or both of a wireless device and an authentication proxy to determine whether to obtain a new application key and establish a new secure transport tunnel for an application session that is being established, or to share an existing application key and secure transport tunnel with one or more application sessions that are already established for the wireless device.

The authentication proxy may use a protocol for communicating with application servers that is confidentially protected and supports authentication between the authentication and the application servers, such that the wireless device can rely on the authentication proxy to effectively authenticate the application server with which an application session is established to the wireless device. The authentication proxy may also be able to provide authentication results for a wireless device to an application server (e.g., on establishing an application session with the application server, or upon request from the application server) to effectively authenticate the wireless device with which an application session is established to the application server.

Thus, an authentication proxy may provide authentication of wireless devices to application servers, as well as provide authentication of application servers to wireless devices, potentially reducing the authentication and security task burden on one or both of the wireless devices and the application servers between which application sessions are established via the authentication proxy, at least according to some embodiments.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 illustrates an exemplary block diagram of a cellular network element, according to some embodiments;

FIG. 6 is a flowchart diagram illustrating aspects of an exemplary possible method for utilizing an authentication proxy in authentication and key management for applications in a wireless communication system, according to some embodiments;

FIGS. 7-8 illustrate examples of possible Authentication and Key Management for Applications architecture schemes in reference point representation for internal external application functions, respectively, according to some embodiments;

FIG. 9 illustrates an example fundamental network model scheme for Authentication and Key Management for Applications, according to embodiments;

FIGS. 10-11 are signal flow diagrams illustrating possible signaling that could be used for key generation and authentication in a cellular communication system utilizing an Authentication and Key Management for Applications framework, according to embodiments;

FIG. 12 illustrates one possible architectural view of an authentication proxy and its environment and reference points, according to embodiments;

FIG. 13 illustrates one possible high level reference model for a network application function using a bootstrapping service, according to some embodiments; and

FIG. 14 illustrates an example of one possible Authentication and Key Management for Applications architecture that can include authentication proxy functionality, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
AKMA: Authentication and Key Management for Applications
AAnF: AKMA Anchor Function
AF: Application Function
AUSF: Authentication Server Function
AP: Authentication Proxy
AS: Application Server
TLS: Transport Layer Security

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™_based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

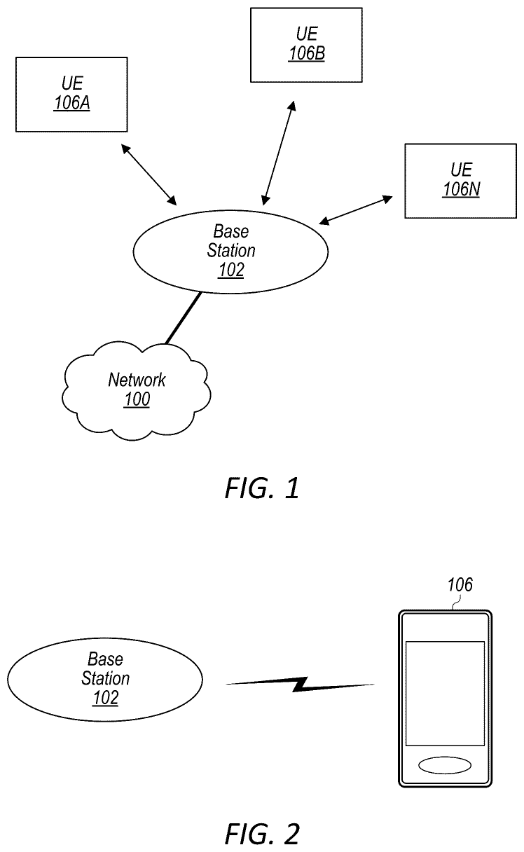

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for utilizing an authentication proxy in authentication and key management for applications in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

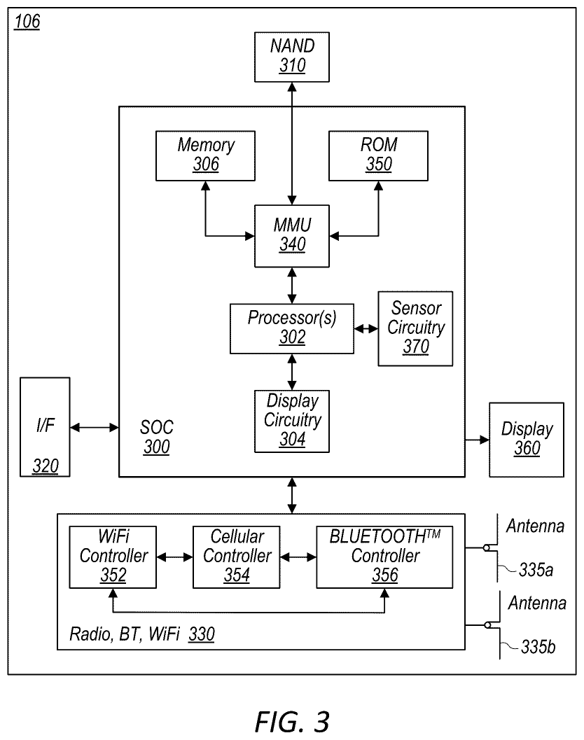

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for utilizing an authentication proxy in authentication and key management for applications in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for utilizing an authentication proxy in authentication and key management for applications in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

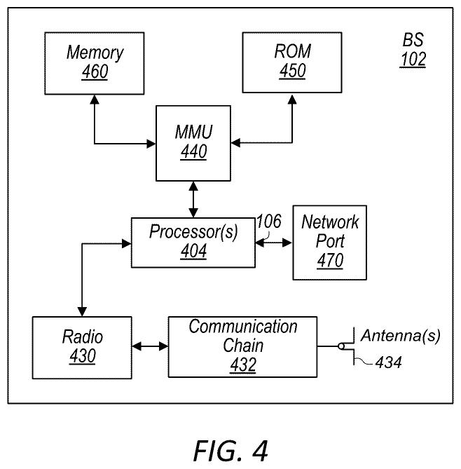

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

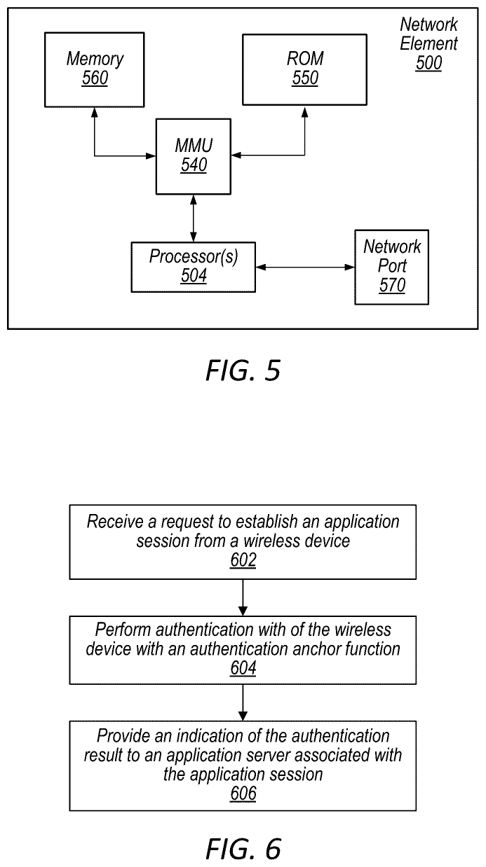

### FIG. 5—Exemplary Block Diagram of a Network Element

FIG. 5 illustrates an exemplary block diagram of a network element 500, according to some embodiments. According to some embodiments, the network element 500 may implement one or more logical functions/entities of a cellular core network, such as a mobility management entity (MME), serving gateway (S-GW), access and management function (AMF), session management function (SMF), authentication server function (AUSF), application function (AF), authentication proxy (AP), application server (AS), etc. It is noted that the network element 500 of FIG. 5 is merely one example of a possible network element 500. As shown, the core network element 500 may include processor(s) 504 which may execute program instructions for the core network element 500. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The network element 500 may include at least one network port 570. The network port 570 may be configured to couple to one or more base stations and/or other cellular network entities and/or devices. The network element 500 may communicate with base stations (e.g., eNBs/gNBs) and/or other network entities/devices by means of any of various communication protocols and/or interfaces.

As described further subsequently herein, the network element 500 may include hardware and software components for implementing and/or supporting implementation of features described herein. The processor(s) 504 of the core network element 500 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof.

### FIG. 6—Authentication Proxy Use in Authentication and Key Management for Applications

As the potential connectivity options and range of possible services available for wireless devices increases, so does the importance of providing robust and efficient authentication techniques in a wireless communication system, e.g., to effectively protect the privacy and integrity of data communicated within and outside of such a system. Introducing authentication proxy functionality within an authentication and key management for applications (AKMA) framework may be one possible technique for providing efficient and effective authentication support in a cellular communication system.

Thus, it may be beneficial to specify techniques for utilizing an authentication proxy in an AKMA framework. To illustrate one such set of possible techniques, FIG. 6 is a flowchart diagram illustrating a method for utilizing an authentication proxy in authentication and key management for applications in a wireless communication system, at least according to some embodiments.

Aspects of the method of FIG. 6 may be implemented by a wireless device and/or an “authentication proxy” cellular network element, e.g., in conjunction with one or more cellular base stations and/or other cellular network elements, such as a UE 106, a BS 102, and a cellular network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 6 are described in a manner relating to the use of communication techniques and/or features associated with 3GPP and/or NR specification documents, such description is not intended to be limiting to the disclosure, and aspects of the method of FIG. 6 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 6 may operate as follows.

A wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

The wireless link(s) between the wireless device and the cellular base station(s) may provide at least a portion of a physical interface on which the wireless device can communicate information (e.g., at higher protocol layers) with other elements of the cellular network and/or entities external to the cellular network. For example, the wireless device may perform primary authentication and/or further authentication activities with one or more cellular network elements in accordance with an Authentication and Key Management for Applications (AKMA) service framework, according to some embodiments.

Primary authentication may be performed between the wireless device and an authentication server function (AUSF) associated with the cellular network, according to some embodiments. Such authentication may include a signaling exchange between the wireless device and the AUSF to generate and provide a primary key (a “K_{AUSF}”) to the wireless device. The wireless device and/or the AUSF may also generate AKMA key information (e.g., an AKMA key or “K_{AKMA}” and AKMA Key Identifier or “A-KID”), e.g., based on the primary key. Some of the authentication (e.g., the A-KID) may be registered by the AUSF with an AKMA anchor function (AAnF) associated with the cellular network, e.g., to support further authentication activities for the wireless device without risk of exposing the primary key or AKMA key of the wireless device through further communication. Note that variations on or alternatives to various aspects of the primary authentication process described herein are also possible and should be considered within the scope of the disclosure.

In 602, the wireless device may provide an application session establishment request to an authentication proxy (AP) associated with the cellular network, and the AP may receive the application session establishment request from the wireless device. The application session establishment request may request that an application session be established between the wireless device and an application server (AS), e.g., via the AP.

In 604, the authentication proxy may perform authentication of the wireless device with the AAnF to obtain an authentication result for the wireless device. To support such authentication, the wireless device may provide the A-KID for its K_{AKMA} to the AP, which the AF may in turn provide the A-KID to the AAnF as part of a request for an application key. Based on such a request, the AAnF may derive an application key (“K_{AF}”) for the wireless device based on the AKMA key for the wireless device and provide an indication of the application key (e.g., along with key expiration time information) back to the AP. If this process is successful and the AP is able to obtain this authentication information for the wireless device, the authentication result may be considered positive or success, otherwise the authentication result may be considered negative or failure, at least according to some embodiments.

The authentication of the wireless device with the AAnF may be performed based on the application session establishment request, e.g., to obtain an application key for the application session being established, as one possibility. As another possibility, if the AP has previously successfully authenticated the wireless device with the AAnF and has an application key (or multiple application keys) for the wireless device, it may be possible that an existing application key for the wireless device can be used for multiple application sessions, and that the AP does not perform authentication of the wireless device with the AAnF for every application session establishment request. As a still further possibility, it may be the case that the AP can perform authentication of the wireless device with the AAnF to obtain a new application key even if the AP has previously successfully authenticated the wireless device with the AAnF and has an application key for the wireless device.

The application key for an application session may be used to support establishment of a transport layer security (TLS) tunnel between the AP and the wireless device, which may be used to communicate data for that application session. If the same application key is used for multiple application sessions, those application sessions may use a shared TLS tunnel, at least according to some embodiments.

Either or both of the AP or the wireless device may be able to impact whether a new application key is generated and TLS tunnel is established for an application session that is being established. For example, as one possibility, the wireless device may determine whether to request a new TLS tunnel for the application session, and may provide an indication of whether a new TLS tunnel is requested for the application session to the AP. Such an indication could be included with the application session establishment request or may be provided separately from the application session establishment request, according to various embodiments. For example, wireless device policy on sharing or establishing independent TLS tunnels for different application sessions may be determined and indicated as a static preference for all application sessions, or may be dynamically determined on a per-session basis and indicated individually for each application session establishment request, according to various embodiments. Additionally, or alternatively, the AP may determine whether to establish a new TLS tunnel for the application session based at least in part on local AP policy.

The determination may be based on any of various possible considerations. As one possibility, the determination may be based at least in part on whether an existing TLS tunnel between the wireless device and the authentication proxy has been established. For example, it may be the case that the AP and/or wireless device determines to establish (or request to have established) a new TLS tunnel if an existing TLS tunnel between the wireless device and the authentication proxy has not been established, and determines not to establish (or does not request to have established) a new TLS tunnel if an existing TLS tunnel between the wireless device and the authentication proxy has been established. In other words, in such a scenario, there may be no limit on the number of application sessions that can share a TLS tunnel, and as long as an existing TLS tunnel has already been established, there may be no need to perform additional authentication to obtain a new application key for the wireless device and establish a new TLS tunnel, since the existing application key and TLS tunnel can serve the new application session as well as any previously established application sessions.

As another possibility, the wireless device and/or the AP may limit the number of application sessions that can share a TLS tunnel. Thus, whether to request a new TLS tunnel for an application session could be determined based at least in part on the number of application sessions served by one or more existing TLS tunnels between the wireless device and the authentication proxy, e.g., such that a new TLS tunnel is not requested if an existing TLS tunnel between the wireless device and the authentication proxy serves fewer than a threshold/limit number of application sessions for the TLS tunnel (e.g., in which case the application session being established can share the existing TLS tunnel), and that a new TLS tunnel is requested if each existing TLS tunnel between the wireless device and the authentication proxy serves at least the threshold/limit number of application sessions for those TLS tunnels (in other words, if all existing TLS tunnels are “full” based on the configured or preferred limit(s) on the number of application sessions that can share those existing TLS tunnels).

Note that it may also be possible that the AP and/or the wireless device can determine whether to establish a new TLS tunnel or share an existing TLS tunnel for an application session based on characteristics of the application session itself (e.g., based on a service associated with the application session, as one possibility) and/or based on application session establishment policy information (e.g., at one or more layers, such as an access stratum (AS) layer of the wireless device, as one possibility). For example, for an application session, it might be preferred by the AP and/or the wireless device to establish a separate application key and an independent TLS tunnel for the application session even if an existing TLS tunnel serves fewer application sessions than the configured or preferred limit for that TLS tunnel, and/or to set a lower limit (e.g., one, as one possibility) on the number of application sessions that can be served by the TLS tunnel of the application session than for one or more other TLS tunnels. As another example, for another application session, it might be preferred by the AP and/or the wireless device that the application session shares an existing TLS tunnel as long as at least one existing TLS tunnel serves fewer application sessions than the configured or preferred limit for that TLS tunnel, and/or to set a higher limit on the number of application sessions that can be served by the TLS tunnel of the application session than for one or more other TLS tunnels.

In 606, the authentication proxy may provide an indication of the authentication result for the wireless device to the application server associated with the application session. The authentication result indication may be provided based at least in part on the request to establish the application session; for example, the AP may forward the authentication result indication to the AS associated with the application session in direct response to the request to establish the application session. In some embodiments, the authentication result indication may be provided in response to a request from the AS for the authentication result for the wireless device (e.g., individually or as part of a request for authentication results for a set of multiple wireless devices). For example, the AP may receive a request for the authentication result from the AS associated with the application session, and may provide the authentication result to the AS in response to the request for the authentication result. The indication of the authentication result may include wireless device identification information as well as an indication of whether the wireless device is authenticated, at least in some embodiments. The wireless device identification information could include a generic public subscription identifier (GPSI), a subscription permanent identifier (SUPI), and/or other types of wireless device identification information.

At least according to some embodiments, the AP may store relationship mapping information between application servers and wireless devices that are authenticated to those application servers. For example, the AP may store information indicating an AS host name and a list of authenticated wireless devices for that AS host name, for each of multiple ASs. Thus, in such a scenario, when the AP provides an authentication result indication for a wireless device to an AS, the AP may accordingly store information indicating that authentication relationship.

As noted already herein, it may be the case that the AP-wireless device interface may include use of a TLS tunnel for security and confidentiality. The AP-AS interface may also be confidentiality and integrity protected, at least according to some embodiments. For example, the AP-AS interface for communication between the AP and the AS may include use of one or more of Hypertext Transfer Protocol (HTTP), HTTP secure (HTTPS), Internet Protocol Security (IPSec), or Internet Key Exchange Version 2 (IKEv2), and may support authentication between the AP and the AS (e.g., the AP may be able to authenticate the AS).

Thus, at least according to some embodiments, the method of FIG. 6 may be used to provide a framework according to which authentication proxy functionality can be used in conjunction with an authentication and key management for applications architecture in a cellular communication system, at least in some instances. Such a framework may be used to reduce the consumption of authentication vectors, to reduce the likelihood of sequence number synchronization failures, and/or to relieve application servers of at least some security tasks, among various possible benefits, at least according to some embodiments.

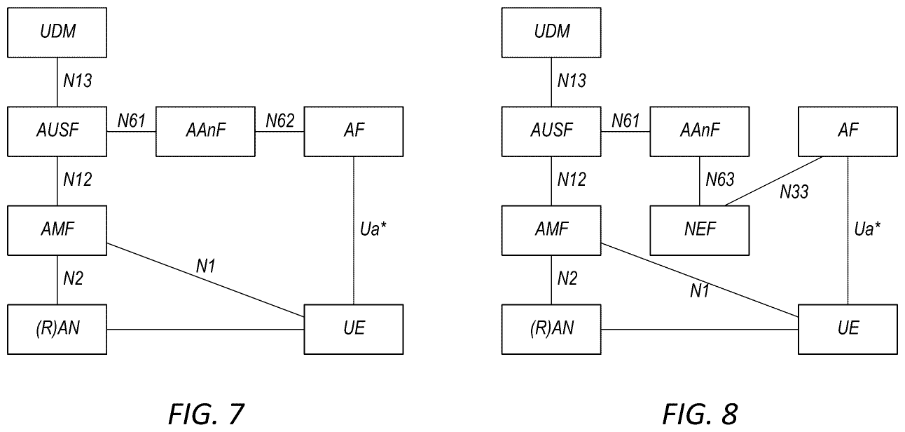

### FIGS. 7-14 and Additional Information

FIGS. 7-14 illustrate further aspects that might be used in conjunction with the method of FIG. 6 if desired. It should be noted, however, that the exemplary details illustrated in and described with respect to FIGS. 7-14 are not intended to be limiting to the disclosure as a whole: numerous variations and alternatives to the details provided herein below are possible and should be considered within the scope of the disclosure.

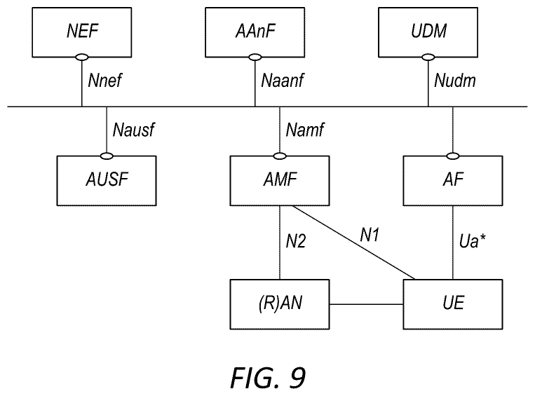

Authentication and Key Management for Applications (AKMA) service may be a feature provided in at least some cellular communication systems. For example, such a feature may be provided in 3GPP Release 17, according to some embodiments. In such a system, an AKMA anchor function (AAnF) may be deployed as a standalone function. Deployments may be able to choose to collocate the AAnF with an Authentication Server Function (AUSF) or with a network exposure function (NEF), e.g., according to network operators' deployment scenarios. FIGS. 7-8 illustrate examples of such possible AKMA architecture schemes in reference point representation for internal application functions (AFs) and external AFs respectively, according to some embodiments. FIG. 9 illustrates an example fundamental network model scheme for AKMA, according to embodiments. At least as one possibility, such an architecture may include a key hierarchy with the following keys: K_{AUSF}, K_{AKMA}, K_{AF}. K_{AUSF} may be generated by AUSF as specified in clause 6 of 3GPP 33.501 v.17.5.0, in one set of embodiments.

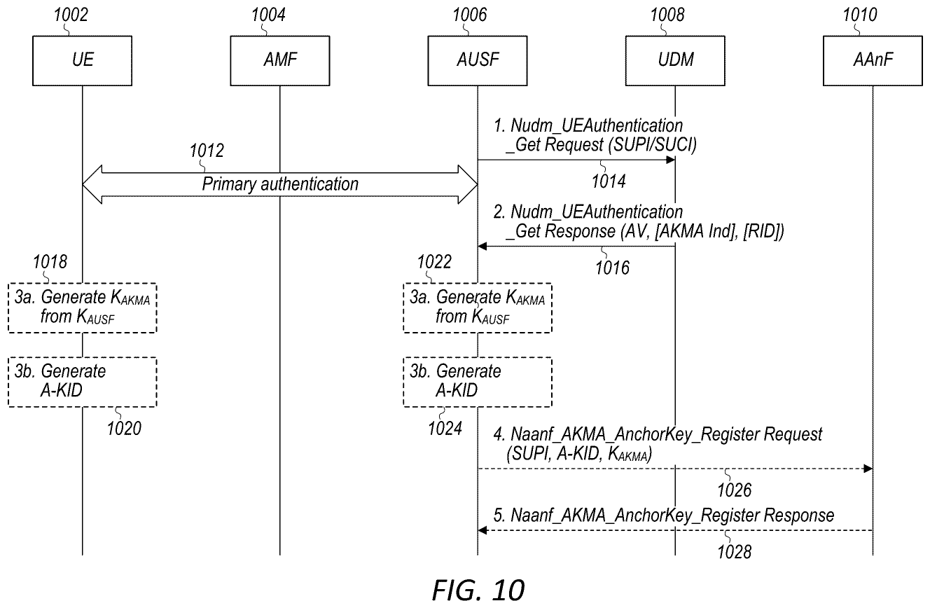

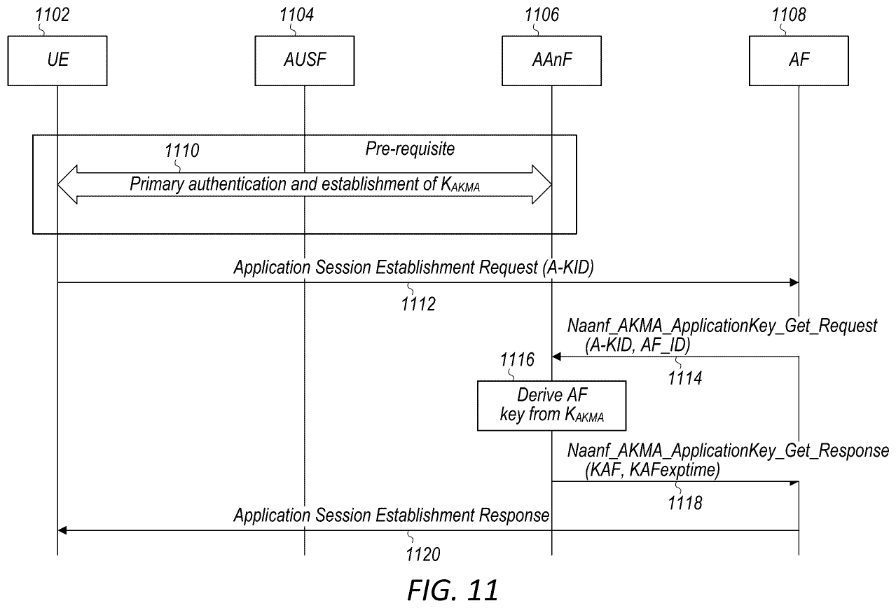

FIGS. 10-11 are signal flow diagrams illustrating possible signaling that could be used for key generation and authentication in a cellular communication system utilizing such an AKMA framework. AKMA may be based on primary authentication, where a UE and a AAnF share the K_{AKMA} and an AKMA Key Identifier (A-KID). FIG. 10 illustrates a possible scheme for deriving K_{AKMA} after primary authentication, according to some embodiments. The illustrated example signaling scheme may include signaling between a UE 1002, AMF 1004, AUSF 1006, unified data management (UDM) 1008, and AAnF 1010. As shown, in 1012, the UE 1002 and AUSF 806 may perform primary authentication. In 1014, the AUSF 1006 may send a UE Authentication request to the UDM 1008, which, in 1016, may send a UE Authentication response back to the AUSF 1006. In 1018 and 1022, the UE 1002 and AUSF 1006 may each respectively generate the K_{AKMA} from the K_{AUSF} for the UE. Similarly, in 1020 and 1024, the UE 1002 and AUSF 1006 may each respectively generate the A-KID for the UE. I, 1026, the AUSF 1006 may send an AKMA Anchor Key Register request to the AAnF 1010, which, in 1028, may send an AKMA Anchor Key Register response back to the AUSF 1006.

FIG. 11 illustrates a possible scheme for K_{AF} generation from K_{AKMA}, when there is no NEF between the AAnF and the AF, according to some embodiments. The illustrated example signaling scheme may include signaling between a UE 1102, AUSF 1104, AAnF 1106, and AF 1108. As shown, in 1110, primary authentication and establishment of a K_{AKMA} for the UE 1102 may be a pre-requisite to the subsequent K_{AF} generation, in the illustrated example scenario. In 1112, the UE 1102 may send an application session establishment request to the AF 1108. In 1114, the AF 1108 may send an AKMA application key request to the AAnF 1106. In 1116, the AAnF 1106 may derive the KA from the K_{AKMA}. In 1118, the AAnF 1106 may send an AKMA application key response back to the AF 1108. In 1120, the AF 1108 may send an application session establishment response back the UE 1102. Note that the UE may derive the K_{AF} in such a scenario before or after sending the application session establishment request message.

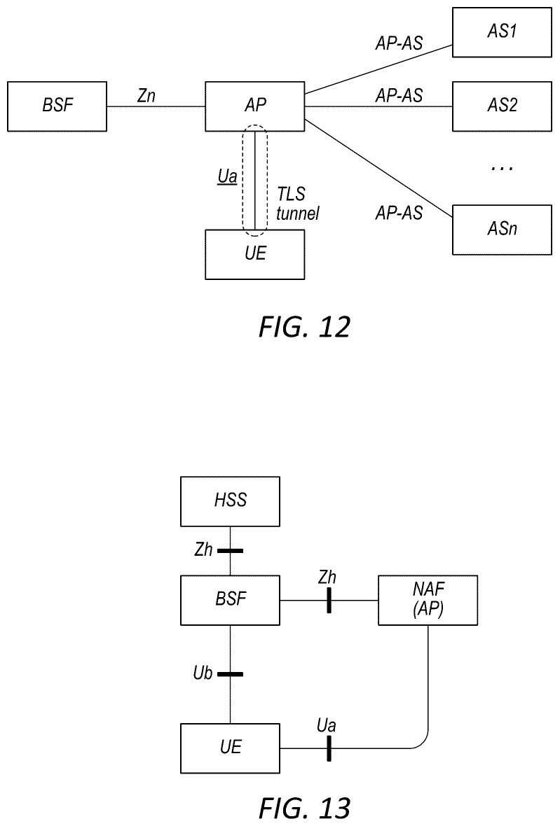

In generic bootstrapping architecture (GBA), an authentication proxy (AP) may be an HTTP proxy that takes the role of a network application function (NAF) for a UE, for example as further described in 3GPP TS 33.222 v.17.1.0. The AP may handle the TLS security relation with the UE and relieve the application server (AS) of this task. Based on the GBA the AP may be able to assure the ASs that a request is coming from an authorized subscriber of the mobile network operator (MNO). FIG. 12 illustrates one possible architectural view of an AP and its environment and reference points. FIG. 13 illustrates one possible high level reference model for a NAF using a bootstrapping service (e.g., implementing AP functionality). When an HTTPS request is destined towards an AS behind an AP, the AP may terminate the TLS tunnel and perform UE authentication. The AP may proxy HTTP requests received from the UE to one or multiple application servers. The AP may add an assertion of identity of the subscriber for use by the AS, when the AP forwards the request from the UE to the AS. The HTTP protocol may be run over the AP-AS reference point, as one possibility. Confidentiality and integrity protection can be provided for the reference point between the AP and the AS using NDS/IP mechanisms (e.g., such as in the manner described in 3GPP TS 33.210 v.17.0.0), at least as one possibility. The Ua reference point may operate in the manner described in 3GPP TS 33.220 [3] v.17.2.0, at least as one possibility.

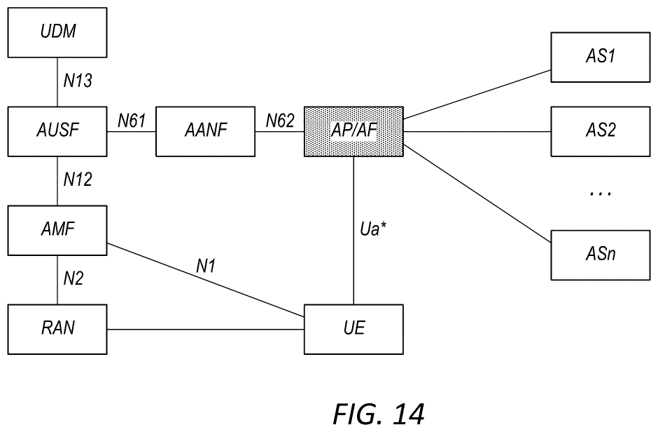

In GBA, some possible benefits from using an AP may include reducing the consumption of authentication vectors and/or minimizing sequence number (SQN) synchronization failures. Additionally, the AP may relieve the AS of at least some security tasks. Inclusion of AP functionality (e.g., as part of or instead of the application function (AF)) in an AKMA framework (e.g., for 3GPP Release 18 AKMA, as one possibility) may provide similar and/or other benefits, at least according to some embodiments. FIG. 14 illustrates an example of one possible AKMA architecture that can include AP functionality, with the AP in the AKMA system taking the role of AF.

At least according to some embodiments, such an AP may be able to authenticate a UE through Ua* (e.g., according to 3GPP TS 33.535 v.17.5.0, as one possibility), and generally have full AF functionality in AKMA. In addition to such AF functionality, the AP may also support other functionalities, potentially including authenticating a UE for an AS, and/or authenticating an AS for a UE. In some instances, an N62 reference point may be used for the interface with AAnF, e.g., following 3GPP TS 33.535 v.17.5.0. The Ua* reference point may be used for the interface with the UE, e.g., following 3GPP TS 33.535 v.17.5.0. The AP-AS reference point may use HTTP or HTTPS, IPSec, or IKEv2 (e.g., as described in 3GPP TS 33.220 v.17.2.0 (Network Domain Security: IP network layer security)), among various possibilities. It may be the case that these interfaces are confidentially protected, e.g., to protect authentication results transferred over these interfaces.

As the proxy between a UE and an AS, the AP may perform the AF functionality (e.g., as described in 3GPP TS 33.535 v.17.5.0), and after successful authentication, the AP may pass the authentication result for a specific UE ID to the AS(s). To provide such authentication proxy functionality, as a possible first step, the AS may request the authentication result for one or more specific UEs, and the AP may respond with the result. As another possibility, the AP could forward to the AS(s) all the authentication results based on UE service request(s) with the information for the AS(s). The format could include the UE ID information and an authentication result indication. The UE ID could include a GPSI, SUPI, or other form of UE identification. The AP may store the mapping relationship between UE(s) and AS(s). As one possibility, the format may be as:
AS host name <−> list of authenticated UEs
   An AP may be able to establish more than one TLS tunnel with a UE; for example, the AF functionality may run more than one AKMA procedure to derive more than one K_{AF} (e.g., based on local policy). For example, for one group of ASs, the AP may perform an AKMA procedure and derive a ‘K_{AF1}’, and for another group of ASs, the AP may run another round of AKMA procedure and derive a ‘K_{AF2}’.

With the AP-AS interfaces, an AP may also be able to authenticate each associated AS. After performing the AKMA procedure (e.g., described in 3GPP TS 33.535 v.17.5.0), an AP and a UE may be mutually authenticated. A UE may be able to establish more than one TLS tunnel with the AP, e.g., when applications in the UE could not or do not wish to share the same TLS tunnel with the AS. As one possibility, the UE could be the entity that decides whether to use independent tunnels or a shared tunnel. In such a scenario, it may be the case that the UE indicates its preference to the AP by including an indication in the request message in the initiation of AKMA (e.g., such as described in 3GPP TS 33.535 v.17.5.0 clause 6.5) to set a new TLS tunnel for this service. Such a UE preference may additionally or alternatively be indicated in step 1 in clause 6.2 in 3GPP TS 33.535 v.17.5.0. As another possibility, the AP could be the entity to decide whether to use independent tunnels or a shared tunnel. In such a scenario, the decision may be based on the local policy. For example, the network might have a limit on the number of ASs for a given KA, such that the AP could decide to establish a new AKMA connection with a UE when a service request would increase the number of ASs above that limit, as one possibility.

In the following further exemplary embodiments are provided.

One set of embodiments may include a method, comprising: by an authentication proxy in a cellular network: receiving a request to establish a first application session from a wireless device; performing authentication of the wireless device with an authentication anchor function (AAnF) associated with the cellular network to obtain an authentication result for the wireless device; and providing an indication of the authentication result to a first application server (AS) associated with the first application session.

According to some embodiments, the indication of the authentication result is provided to the first AS based at least in part on the request to establish the first application session.

According to some embodiments, the method further comprises: receiving a request for the authentication result from the first AS, wherein the indication of the authentication result is provided to the first AS based at least in part on the request for the authentication result from the first AS.

According to some embodiments, the indication of the authentication result includes wireless device identification information.

According to some embodiments, the wireless device identification information includes one or more of: a generic public subscription identifier (GPSI); or a subscription permanent identifier (SUPI).

According to some embodiments, the method further comprises: storing relationship mapping information between application servers and wireless devices that are authenticated to those application servers.

According to some embodiments, the method further comprises: receiving an indication of whether a new transport layer security (TLS) tunnel is requested for the first application session from the wireless device; determining to establish a new TLS tunnel for the first application session if the indication from the wireless device requests a new TLS tunnel for the first application session; and determining to use an existing TLS tunnel for the first application session if the indication from the wireless device does not request a new TLS tunnel for the first application session.

According to some embodiments, the request to establish the first application session includes the indication of whether a new TLS tunnel is requested for the first application session.

According to some embodiments, the indication of whether a new TLS tunnel is requested for the first application session is provided separately from the request to establish the first application session.

According to some embodiments, the method further comprises: determining whether to establish a new transport layer security (TLS) tunnel for the first application session based at least in part on a number of application sessions served by one or more existing TLS tunnels between the wireless device and the authentication proxy, wherein a new TLS tunnel is not established for the first application session if an existing TLS tunnel between the wireless device and the authentication proxy serves fewer than a threshold number of application sessions, wherein a new TLS tunnel is established for the first application session if each existing TLS tunnel between the wireless device and the authentication proxy serves at least the threshold number of application sessions.

According to some embodiments, an authentication proxy-application server interface for communication between the authentication proxy and the first AS includes use of one or more of: Hypertext Transfer Protocol (HTTP); HTTP secure (HTTPS); Internet Protocol Security (IPSec); or Internet Key Exchange Version 2 (IKEv2).

Another set of embodiments may include a network entity configured to implement authentication proxy functionality in a cellular network, comprising: one or more processors; and a memory having instructions stored thereon, which when executed by the one or more processors, perform steps of the method of any of the preceding examples.

Yet another set of embodiments may include a method, comprising: by a wireless device: establishing a wireless link with a cellular base station, wherein the cellular base station is associated with a cellular network; performing primary authentication with an authentication server function (AUSF) associated with the cellular network; determining whether to request a new transport layer security (TLS) tunnel for an application session; and providing an application session establishment request to an authentication proxy associated with the cellular network to establish the application session, wherein the application session establishment request includes authentication information generated based at least in part on the primary authentication with the AUSF.

According to some embodiments, the method further comprises: providing an indication of whether a new TLS tunnel is requested for the application session to the authentication proxy.

According to some embodiments, whether to request a new TLS tunnel for the application session is determined based at least in part on whether an existing TLS tunnel between the wireless device and the authentication proxy has been established, wherein a new TLS tunnel is not requested if an existing TLS tunnel between the wireless device and the authentication proxy has been established, wherein a new TLS tunnel is requested if an existing TLS tunnel between the wireless device and the authentication proxy has not been established.

According to some embodiments, whether to request a new TLS tunnel for the application session is determined based at least in part on a number of application sessions served by one or more existing TLS tunnels between the wireless device and the authentication proxy, wherein a new TLS tunnel is not requested if an existing TLS tunnel between the wireless device and the authentication proxy serves fewer than a threshold number of application sessions, wherein a new TLS tunnel is requested if each existing TLS tunnel between the wireless device and the authentication proxy serves at least the threshold number of application sessions.

According to some embodiments, whether to request a new TLS tunnel for the application session is determined based at least in part on one or more of: a service associated with the application session; or access stratum (AS) layer application session establishment preference information.

According to some embodiments, the application session establishment request includes the indication of whether a new TLS tunnel is requested for the application session.

According to some embodiments, the indication of whether a new TLS tunnel is requested for the application session is provided separately from the application session establishment request.

Still another set of embodiments may include a wireless device, comprising: one or more processors; and a memory having instructions stored thereon, which when executed by the one or more processors, perform steps of the method of any of the preceding examples.

A further set of embodiments may include a computer program product, comprising computer instructions which, when executed by one or more processors, perform steps of the method of any of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
performing functions of an application function (AF) by an authentication proxy (AP) in a cellular network, the functions of the AF performed by the AP comprising:
receiving a request to establish a first application session from a wireless device;
performing authentication of the wireless device with an authentication anchor function (AAnF) associated with the cellular network to obtain an authentication result for the wireless device; and
providing an indication of the authentication result associated with the first application session.

2. The method of claim 1,
wherein the indication of the authentication result is provided to a first application server (AS) based at least in part on the request to establish the first application session.

3. The method of claim 1, wherein the method further comprises:
receiving a request for the authentication result from a first application server (AS),
wherein the indication of the authentication result is provided to the first AS based at least in part on the request for the authentication result from the first AS.

4. The method of claim 1,
wherein the indication of the authentication result includes wireless device identification information.

5. The method of claim 4, wherein the wireless device identification information includes one or more of:
a generic public subscription identifier (GPSI); or
a subscription permanent identifier (SUPI).

6. The method of claim 1, wherein the method further comprises:
storing relationship mapping information between application servers and wireless devices that are authenticated to those application servers.

7. The method of claim 1, wherein the method further comprises:
receiving an indication of whether a new transport layer security (TLS) tunnel is requested for the first application session from the wireless device;
determining to establish a new TLS tunnel for the first application session if the indication from the wireless device requests a new TLS tunnel for the first application session; and
determining to use an existing TLS tunnel for the first application session if the indication from the wireless device does not request a new TLS tunnel for the first application session.

8. The method of claim 7,
wherein the request to establish the first application session includes the indication of whether a new TLS tunnel is requested for the first application session.

9. The method of claim 7,
wherein the indication of whether a new TLS tunnel is requested for the first application session is provided separately from the request to establish the first application session.

10. The method of claim 1, wherein the method further comprises:
determining whether to establish a new transport layer security (TLS) tunnel for the first application session based at least in part on a number of application sessions served by one or more existing TLS tunnels between the wireless device and the authentication proxy,
wherein a new TLS tunnel is not established for the first application session if an existing TLS tunnel between the wireless device and the authentication proxy serves fewer than a threshold number of application sessions,
wherein a new TLS tunnel is established for the first application session if each existing TLS tunnel between the wireless device and the authentication proxy serves at least the threshold number of application sessions.

11. The method of claim 1,
wherein an authentication proxy-application server interface for communication between the authentication proxy and the first AS includes use of one or more of:
Hypertext Transfer Protocol (HTTP);
HTTP secure (HTTPS);
Internet Protocol Security (IPSec); or
Internet Key Exchange Version 2 (IKEv2).

12. An apparatus, comprising:
a processor configured to, when executing instructions stored in a memory, perform operations comprising:
transmitting, to an authentication proxy (AP) authentication proxy in a cellular network, a request to establish a first application session, the request to establish the first application session useable for:
performing authentication of the wireless device with an authentication anchor function (AAnF) associated with the cellular network to obtain an authentication result; and
providing an indication of the authentication result associated with the first application session.

13. The apparatus of claim 12,
wherein the indication of the authentication result includes wireless device identification information.

14. The apparatus of claim 13, wherein the wireless device identification information includes a generic public subscription identifier (GPSI).

15. The apparatus of claim 13, wherein the wireless device identification information includes a subscription permanent identifier (SUPI).

16. The apparatus of claim 12, the operations further comprising:
transmitting, to the AP, an indication of whether a new transport layer security (TLS) tunnel is requested for the first application session.

17. A method, comprising:
transmitting, to an authentication proxy (AP) authentication proxy in a cellular network, a request to establish a first application session, the request to establish the first application session useable for:
performing authentication of the wireless device with an authentication anchor function (AAnF) associated with the cellular network to obtain an authentication result; and
providing an indication of the authentication result associated with the first application session.

18. The method of claim 17,
wherein the indication of the authentication result includes wireless device identification information.

19. The apparatus method of claim 18, wherein the wireless device identification information includes at least one of:
a generic public subscription identifier (GPSI); or
a subscription permanent identifier (SUPI).

20. The method of claim 17, the operations further comprising:
transmitting, to the AP, an indication of whether a new transport layer security (TLS) tunnel is requested for the first application session.
